(19) United States
(12) Patent Application Publication
(10) Pub. No.: US 2023/0339794 A1
(43) Pub. Date: Oct. 26, 2023

(54) REMOVAL OF HARDNESS USING TEMPLATE ASSISTED CRYSTALLIZATION FOR ELECTRODIALYSIS DESALINATION OF SALINE WATER

(71) Applicant: MIS IP Holdings, LLC, Houston, TX (US)

(72) Inventors: Ethan L. DEMETER, The Woodlands, TX (US); Mavis C. Y. WONG, Houston, TX (US)

(73) Assignee: MIS IP Holdings, LLC, Houston, TX (US)

(21) Appl. No.: 18/184,084

(22) Filed: Mar. 15, 2023

Related U.S. Application Data
(60) Provisional application No. 63/333,251, filed on Apr. 21, 2022.

(51) Int. Cl. C02F 5/02; C02F 1/469; C02F 1/52; C02F 1/46; B01D 61/46

(52) U.S. Cl. CPC C02F 5/02; C02F 1/4693; C02F 1/52; C02F 1/4602; B01D 61/46; C02F 2001/5218; C02F 2301/046; B01D 2311/08

(57) ABSTRACT

Provided are water treatment systems for reducing hardness in water. The water treatment systems include an electrodialysis device comprising a brine inlet stream, a feed stream, a brine outlet stream, and a product outlet stream, and a template assisted crystallization (TAC) filter comprising a brine inlet stream and a brine outlet stream. The brine inlet stream comprises the brine outlet stream of the electrodialysis device and the brine inlet stream of the electrodialysis device comprises the brine outlet stream of the TAC filter. The system pressure is reduced by 30-60% when the brine stream goes through a TAC filter than a system without the filter. An acid supply and an acid feed stream may also be included, wherein the brine inlet stream of the electrodialysis device comprises the brine outlet stream of the TAC filter and the acid feed stream.

### CROSS-REFERENCE TO RELATED APPLICATIONS

This application claims the benefit of U.S. Provisional application No. 63/333,251, filed Apr. 21, 2022, the entire contents of which is incorporated herein by reference.

### FIELD

The present disclosure relates to a process for removing hardness from water, and, more specifically, removing hardness from water using template assisted crystallization.

### BACKGROUND

Hardness is defined by the concentration of divalent cations Ca²⁺ and Mg²⁺ in a water source. The higher the concentration of these divalent cations, the more likely the water is to form scale. Although hardness is not a regulated primary drinking water standard, water with hardness levels greater than 120 mg/L as CaCO₃ is considered hard water. Hard water is more likely to form limescale on piping, faucets and fixtures that can lead to aesthetic issues and clogging of plumbing units. Scale formation on heating elements, boilers and pipework will also lead to reduced efficiency and lifetime of systems.

There have been many efforts to either remove or reduce the hardness in water sources. The most common is ion exchange, a softening technique, which uses resins to remove the hardness of the water by exchanging monovalent Na⁺ and K⁺ with hardness ions (Mg²⁺ and Ca²⁺). Over time when the ion exchange capacity is depleted, concentrated brine is used to regenerate the ion exchange resins, which pose an environmental disposal concern. Lime softening is also used to raise the pH of the water to precipitate out CaCO₃ and Mg(OH)₂. Lime softening is typically combined with settling tanks and filtration devices to remove precipitated sludge, as well as membrane processes to remove added TDS in the water. This process requires chemicals and a large footprint due to the additional unit processes required for treatment.

Other processes for removing hardness in water include membrane applications. Acid dosing is common in membrane processes for removing hardness. The Langelier Saturation Index (LSI) is a rough measure of the scale forming potential or corrosiveness of a water by accounting for the water temperature, pH, TDS and alkalinity. Water with an LSI >0.30 is considered scale forming and an LSI <−0.30 is considered corrosive. Acid dosing has been used to reduce the pH of waters with high saturation indices to prevent scaling on the membrane surfaces. Depending on the scaling potential of the water, a large amount of acid may be required to reduce the LSI of the water.

### SUMMARY

Described herein are processes, systems, and methods for removing hardness from water using template assisted crystallization (TAC) combined with electrodialysis. As explained above, membrane separation techniques (e.g., electrodialysis) often require the use of large amounts of acid to reduce the saturation index of the water, or the hardness of the water. The application of TAC in the hardness removal process can minimize the amount of acid required.

TAC is a salt-free technology that a requires only a small footprint compared to other separation technologies. TAC uses polymeric resins/media to provide nucleation sites for Ca²⁺, Mg²⁺, and HCO₃₋ to combine into stable microcrystals. These stable microcrystals do not adhere to surfaces, and thus, can prevent scale formation. Once the insoluble microcrystals become too large for the nucleation site, the microcrystals detach from the TAC media and flow freely through the system, allowing them to be removed from the water stream. In most commercial applications, TAC media cartridges and resin beds have an average recommended replacement time of 3 years. Further, TAC units are simple to operate and do not require electricity, the addition of chemicals, or the disposal of chemical waste. Accordingly, TAC is a more efficient and environmentally-friendly method of removing hardness from water.

Additionally, as explained above, the disclosed processes for removing hardness from water include TAC combined with electrodialysis or electrodialysis reversal (EDR). In EDR processes, naturally occurring salts are separated from a feed water through ion exchange membranes under an applied voltage across a pair of electrodes. During the process, the feed water is separated into a dilate (process) and a concentrate (brine) stream. Depending on the quality of the feed water, acid is continuously dosed into the brine stream to reduce the hardness or the presence of dissolved divalent cations in the brine to prevent scaling on the membranes. However, a significant amount of acid is required to prevent scaling, particularly for a brackish water treatment system.

Accordingly, disclosed herein is a process for removing hardness from water that includes TAC coupled with electrodialysis reversal. Specifically, the TAC component is used to treat the brine or concentrate stream of the EDR component, eliminating or minimizing the amount of acid that would otherwise be required to prevent or reduce scaling in the system. By eliminating or reducing the acid required, the cost of the process may be decreased, the efficiency of the process may be increased, and the environmental impact of the process may be decreased.

In some embodiments, provided is a water treatment system for reducing water hardness, the water treatment system comprising: an electrodialysis device comprising a brine inlet stream, a feed stream, a brine outlet stream, and a product outlet stream, a template assisted crystallization (TAC) filter comprising a brine inlet stream and a brine outlet stream, wherein the brine inlet stream comprises the brine outlet stream of the electrodialysis device and the brine inlet stream of the electrodialysis device comprises the brine outlet stream of the TAC filter, wherein a system pressure of the water treatment system is 30-60% less than a system pressure of a process without a TAC filter.

In some embodiments of the water treatment system, the water treatment system comprises an acid supply and an acid feed stream, wherein the brine inlet stream of the electrodialysis device comprises the brine outlet stream of the TAC filter and the acid feed stream.

In some embodiments of the water treatment system, the feed stream comprises water having 30-35 ppm Na+.

In some embodiments of the water treatment system, the feed stream comprises water having 0-5 ppm Mg2+.

In some embodiments of the water treatment system, the feed stream comprises water having 0-3 ppm K+.

In some embodiments of the water treatment system, the feed stream comprises water having 40-70 ppm Ca2+.

In some embodiments of the water treatment system, a dissolved ion concentration of the product outlet stream is at least 25% less than the dissolved ion concentration of the feed stream.

In some embodiments of the water treatment system, a dissolved ion concentration of the product outlet stream is at least 40% less than the dissolved ion concentration of the feed stream.

In some embodiments of the water treatment system, the acid feed stream comprises at least one of 31% hydrochloric acid or 98% sulfuric acid.

In some embodiments, a method for reducing water hardness is provided, the method comprising: routing a brine inlet stream and a feed stream to an electrodialysis device; and routing a brine outlet stream of the electrodialysis device to a template assisted crystallization (TAC) filter, wherein the brine inlet stream of the electrodialysis device comprises a brine outlet stream of the TAC filter, and a system pressure of the method is 30-60% less than a system pressure of a method without a TAC filter.

In some embodiments of the method, the method comprises an acid supply and an acid feed stream, wherein the brine inlet stream of the electrodialysis device comprises the brine outlet stream of the TAC filter and the acid feed stream.

In some embodiments of the method, the feed stream comprises water having 30-35 ppm Na+.

In some embodiments of the method, the feed stream comprises water having 0-5 ppm Mg2+.

In some embodiments of the method, the feed stream comprises water having 0-3 ppm K+.

In some embodiments of the method, the feed stream comprises water having 40-70 ppm Ca2+.

In some embodiments of the method, a dissolved ion concentration of a product outlet stream flowing from the electrodialysis device is at least 25% less than the dissolved ion concentration of the feed stream.

In some embodiments of the method, a dissolved ion concentration of a product outlet stream flowing from the electrodialysis device is at least 40% less than the dissolved ion concentration of the feed stream.

In some embodiments of the method, the acid feed stream comprises at least one of 31% hydrochloric acid or 98% sulfuric acid.

In some embodiments, any one or more of the features, characteristics, or elements discussed above with respect to any of the embodiments may be incorporated into any of the other embodiments mentioned above or described elsewhere herein.

### BRIEF DESCRIPTION OF THE FIGURES

FIG. 1 shows a hardness removal process comprising an electrodialysis reversal device and a TAC filter, according to some embodiments;

FIG. 2 shows a comparison of the pressure increase in the system of FIG. 1 through 40 minutes cycles with and without a TAC filter, according to some embodiments; and

FIG. 3 shows a comparison of the pressure increase in the system of FIG. 1 between systems without TAC treatment or acid dosing, brine concentration with acid dosing, brine concentration with TAC treatment, and without brine concentration according to some embodiments.

### DETAILED DESCRIPTION

Described herein are processes, systems, and methods for removing hardness from water using template assisted crystallization (TAC) combined with electrodialysis. As explained above, membrane separation techniques (e.g., electrodialysis) often require the use of large amounts of acid to reduce the saturation index of the water, or the hardness of the water. The application of TAC in the hardness removal process can minimize the amount of acid required, thus reducing the cost of reducing/removing the hardness of the water, reducing the environmental impact, and increasing the efficiency of the system. In some embodiments, the TAC and/or acid dosing processes are applied to a high-salinity brine stream, that may be recirculated back into the electrodialysis unit.

As explained above, TAC is a salt-free technology that a requires only a small footprint compared to other separation technologies. TAC uses polymeric resins/media to provide nucleation sites for Ca²⁺, Mg²⁺, and HCO₃₋ to combine into stable microcrystals. These stable microcrystals do not adhere to surfaces, and thus, can prevent scale formation in the system. Once the insoluble microcrystals become too large for the nucleation site, the microcrystals detach from the TAC media and flow freely through the system, allowing them to be removed from the water stream. In most commercial applications, TAC media cartridges and resin beds have an average recommended replacement time of 3 years. Further, TAC units are simple to operate and do not require electricity, the addition of chemicals, or the disposal of chemical waste. Accordingly, TAC is a more efficient and environmentally friendly method of removing hardness from water.

The processes, systems, and methods disclosed herein combine a TAC filter with an electrodialysis reversal (EDR) system to remove hardness more effectively from water. As explained herein, the salinity of brine streams in water treatment processes increases throughout the water treatment, and conventional EDR systems require significant amounts of acid to control (i.e., lower) the salinity of a high-salinity brine stream and to prevent scaling in the brine chamber and pipeline that would otherwise occur due to the high salinity. Without controlling the salinity of the brine stream, the scaling can cause damage to the chamber and piping. However, by incorporating an in-line TAC filter into a conventional EDR system as described herein, the amount of acid needed to lower the salinity of the high-salinity brine streams can be reduced, if not eliminated. Further, the incorporation of an in-line TAC filter reduces the complexity of the system since TAC does not require the use of any chemicals or additional filtration devices.

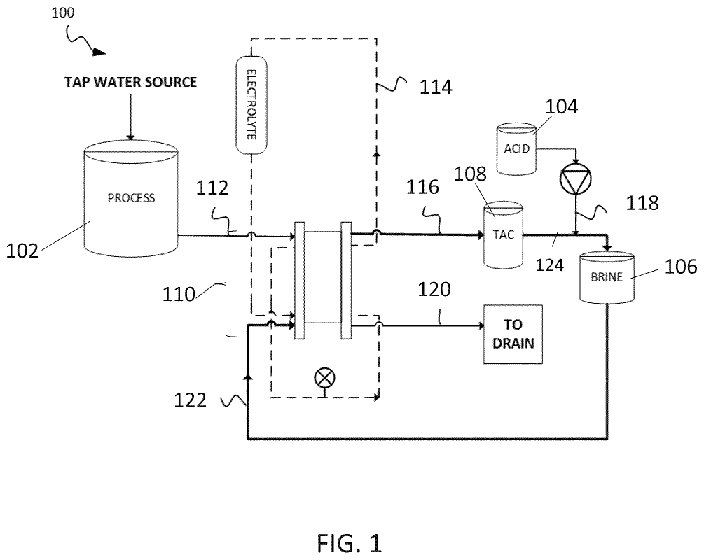

FIG. 1 shows a hardness removal process 100 comprising an electrodialysis device 110 and a TAC filter 108, according to some embodiments.

The system consists of one or more electrodialysis devices 110. Each electrodialysis device 110 includes an anode, electrolyte chambers, cation exchange membranes, brine chambers, anion exchange membranes, diluate chambers, and a cathode. The brine and diluate chambers are connected in parallel. A plurality of electrodialysis devices 110 may be connected in series in order to improve the quality of the processed water, i.e. lower the resulting salt concentration. An electrolyte solution is passed through the electrode chambers of the electrodialysis cell to minimize scaling, to minimize off gassing, and to maintain the resistance at the electrodes.

In some embodiments, the height of each of the brine and diluate chamber is from 0.05-0.1 inches, 0.02-0.04 inches, or 0.01-0.02 inches. In some embodiments, the number of anion and cation exchange membrane pairs of each electrodialysis device 110 is between 50-150 cell pairs. Depending on the number of cell pairs and the quality of the feed water, the membrane stack of each electrodialysis device may be operated at a voltage of 50 V-180 V. In some embodiments, the voltage may be less than or equal to 180, 150, or 100 V. In some embodiments, the voltage may be greater than or equal to 50, 100, or 180 V.

As shown in the Figure, feed stream 112 is fed into electrodialysis device 110 from feed supply 102. In some embodiments, the water of feed supply 102 and feed stream 112 may comprise city tap water. In some embodiments, the water of feed supply 102 and feed stream 112 may have an initial conductivity of 450-550 μS/cm. In some embodiments, the initial conductivity may be less than or equal to 550, 525, 500, or 475 μS/cm. In some embodiments, the initial conductivity may be greater than or equal to 450, 475, 500, or 525 μS/cm. In some embodiments, the water of feed supply 102 and feed stream 112 may comprise a plurality of dissolved ions such as, but not limited to, Na⁺, K⁺, Mg²⁺, and/or Ca²⁺. In some embodiments, water of feed supply 102 and feed stream 112 may comprise 0-100 ppm Na⁺. In some embodiments, water of feed supply 102 and feed stream 112 may comprise less than or equal to 100, 90, 80, 70, 60, 50, 40, 30, or 20 ppm Na⁺. In some embodiments, water of feed supply 102 and feed stream 112 may comprise greater than or equal to 0, 10, 20, 30, 40, 50, 60, 70, or 80 ppm Na⁺. In some embodiments, water of feed supply 102 and feed stream 112 may comprise 0-50 ppm K⁺. In some embodiments, water of feed supply 102 and feed stream 112 may comprise less than or equal to 50, 40, 30, 20, 10, 5, 4, 3, 2, or 1 ppm K⁺. In some embodiments, water of feed supply 102 and feed stream 112 may comprise greater than or equal to 0, 1, 2, 3, 4, 5, 10, 20, 30, or 40 ppm K⁺. In some embodiments, water of feed supply 102 and feed stream 112 may comprise 0-50 ppm Mg²⁺. In some embodiments, water of feed supply 102 and feed stream 112 may comprise less than or equal to 50, 40, 30, 20, 10, 5, 4, 3, 2, or 1 ppm Mg²⁺. In some embodiments, water of feed supply 102 and feed stream 112 may comprise greater than or equal to 0, 1, 2, 3, 4, 5, 10, 20, 30, or 40 ppm Mg²⁺. In some embodiments, water of feed supply 102 and feed stream 112 may comprise 10-200 ppm Ca²⁺. In some embodiments, water of feed supply 102 and feed stream 112 may comprise less than or equal to 200, 150, 100, or 50 ppm Ca²⁺. In some embodiments, water of feed supply 102 and feed stream 112 may comprise greater than or equal to 10, 50, 100, or 150 ppm Ca²⁺. In some embodiments, the water of feed supply 102 and feed stream 112 may have a Langelier Saturation Index (LSI) of 0-1. When the LSI is equal to or less than 0.5, there is little to no scaling potential. In some embodiments, the LSI of the water of feed supply 102 and feed stream 112 may be less than or equal to 1, 0.9, 0.8, 0.7, 0.6, 0.5, 0.4, 0.3, 0.2, or 0.1. In some embodiments, the LSI of the water of feed supply 102 and feed stream 112 may be greater than or equal to 0, 0.1, 0.2, 0.3, 0.4, 0.5, 0.6, 0.7, 0.8, or 0.9.

Feed stream 112 is fed into electrodialysis device 110 along with brine inlet stream 122. The outlet streams of electrodialysis device 110 include brine outlet stream 116 and product stream 120. As shown, product stream 120 is sent to drain as the TAC is being tested for the brine stream. In some embodiments, product stream 120 would be used for customer application. In some embodiments, the product stream 120 may have a conductivity of 110-170 μS/cm. In some embodiments, the conductivity of the product stream 120 may be less than or equal to 170, 160, 150, 140, 130, or 120 μS/cm. In some embodiments, the conductivity of the product stream 120 may be greater than or equal to 110, 120, 130, 140, 150, or 160 μS/cm. In some embodiments, product stream 120 comprises 0-30 ppm Na⁺. In some embodiments, the product stream 120 comprises less than or equal to 30, 20, or 10 ppm Na⁺. In some embodiments, the product stream 120 comprise greater than or equal to 0, 10, or 20 ppm Na⁺. In some embodiments, the product stream 120 comprises 0 -2 ppm K⁺. In some embodiments, the product stream 120 comprises less than or equal to 2, 1.5, or 1 ppm K⁺. In some embodiments, the product stream 120 comprises greater than or equal to 0, 0.5, or 1 ppm K⁺. In some embodiments, the product stream 120 comprises 0-5 ppm Mg²⁺. In some embodiments, the product stream 120 comprises less than or equal to 5, 4, 3, 2, or 1 ppm Mg²⁺. In some embodiments, the product stream 120 comprises 0-10 ppm Ca²⁺. In some embodiments, the product stream 120 comprises less than or equal to 10, 8, 6, 4, or 2 ppm Ca²⁺. In some embodiments, the product stream 120 comprises greater than or equal to 0, 2, 4, 6, or 8 ppm Ca²⁺. In some embodiments, the LSI of the product outlet stream 120 is <0.2, indicating no propensity to scale.

In some embodiments, brine outlet stream 116 may have a conductivity of 2000-50,000 μS/cm. In some embodiments, the conductivity of brine outlet stream 116 is less than or equal to 50,000, 25,000, 10,000 5,000, or 3,000 μS/cm. In some embodiments, the conductivity of brine outlet stream 116 may be greater than or equal to 2,000, 3,000, 5,000, 10,000, or 25,000 μS/cm. Further, in some embodiments, the LSI of the brine outlet stream 116 is 1-10. In some embodiments, the LSI of the brine outlet stream is less than or equal to 10, 9, 8, 7, 6, 5, 4, 3, or 2. In some embodiments, the LSI of the brine outlet stream is greater than or equal to 1, 2, 3, 4, 5, 6, 7, 8, or 9. As the LSI of the brine outlet stream 116 increases, so too does the amount of acid needed in a conventional electrodialysis process relying on acid dosing to reduce the hardness of the brine outlet stream 116. Additionally, an LSI of 2 or greater indicates a high potential to scale.

As shown in the FIGURE, brine outlet stream 116 is fed into TAC filter 108. In some embodiments, the specific media of TAC filter 108 may be selected to target particular ions. Suitable commercially available TAC media can be purchased from companies such as ecoTAC™, Watts® and Next™ Scale Stop.

The outlet stream of TAC filter 108 is treated brine stream 122. At 4000 μS/cm in the brine outlet stream, the Na⁺ ranges from 200-300 ppm, K⁺ ranges from 100-300 ppm, Mg²⁺ ranges from 100-200 ppm and Ca²⁺ ranges from 400-800 ppm.

In some embodiments, acid dosing may also be used to reduce the hardness of the high-salinity brine stream. For example, acid may be added to the treated brine stream 122 to lower the alkalinity, in addition to the brine outlet stream 116 being treated by TAC filter 108. Suitable acids that may be used for acid dosing can include 98% sulfuric acid or 31% hydrochloric acid.

In some embodiments, over time, the brine chamber in the stack (the flow channels for the brine to flow through in the stack) and/or piping will scale to a level at which they need to be cleaned. For example, the media of the TAC filter 108 may need to be replaced, causing the TAC filter 108 to not reduce the alkalinity of the brine outlet stream 116 adequately. Thus, to measure the scaling in the system, the pressure in the system (particularly in the brine chamber) is monitored. As scale builds up in the brine chamber or in the brine pipelines 116, system pressure increases. Once the system pressures reach or exceed a threshold value, the system should be cleaned. To clean the system, three steps should be followed: (1) dumping the brine solution, (2) flushing the system with tap water until the brine outlet stream 118 reaches <1000 μS/cm, and (3) restarting the run cycle with fresh feed water in the brine tank.

The pressure of the system 100 can directly indicate the amount of scaling that has accumulated (e.g., in the brine chamber and/or pipeline). An increase in system pressure also indicates an inefficient process as the pumps are trying to maintain the same flowrate at a much higher pumping power. Thus, once the system pressure reaches a certain point, the system should be cleaned.

In some embodiments, treating the brine outlet stream 116 with TAC filter 108 can decrease the system pressure relative to a system with no TAC filter 108 (nor acid dosing, all else being equal) by 20-80%. In some embodiments, treating the brine outlet stream 116 with TAC filter 108 can decrease the system pressure relative to a system with no TAC filter 108 (nor acid dosing, all else being equal) by less than or equal to 80, 70, 60, 50, 40, or 30%. In some embodiments, treating the brine outlet stream 116 with TAC filter 108 can decrease the system pressure relative to a system with no TAC filter 108 (nor acid dosing, all else being equal) by greater than or equal to 20, 30, 40, 50, 60, or 70%.

In some embodiments, treating the brine outlet stream 116 with acid 104 can decrease the system pressure relative to a system with no acid 104 (nor TAC filter 108, all else being equal) by 20-80%. In some embodiments, treating the brine outlet stream 116 with acid 104 can decrease the system pressure relative to a system with no acid 104 (nor TAC filter 108, all else being equal) by less than or equal to 80, 70, 60, 50, 40, or 30%. In some embodiments, treating the brine outlet stream 116 with acid 104 can decrease the system pressure relative to a system with no acid 104 (nor TAC filter 108, all else being equal) by greater than or equal to 20, 30, 40, 50, 60, or 70%.

In some embodiments, the total dissolved ion concentration of product stream 120 is 10-80% less than that of feed stream 112. In some embodiments, the total dissolved ion concentration of product stream 120 is less than or equal to 80, 70, 60, 50, 40, or 30% less than that of feed stream 112. In some embodiments, the total dissolved ion concentration of product stream 120 is greater than or equal to 10, 20, 30, 40, 50, or 60% less than that of feed stream 112.

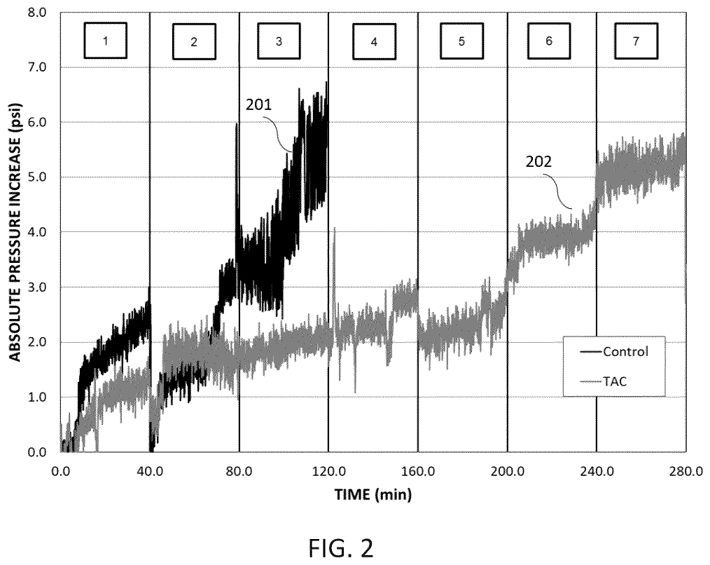

Example 1: FIG. 2 shows a comparison of the pressure increase in the system of FIG. 1 through 40 minutes cycles with and without a TAC filter, according to some embodiments. As explained above, system pressure can be a direct indicator of the amount of scaling in the system. Accordingly, FIG. 2 shows the pressure increases of two different processes: a control 201 and a TAC-treated process 202.

The control 201 includes no alkalinity treatment (neither TAC nor acid dosing), and operated for 3 cycles of 40 minutes each. As shown in the Figure, control 201 experiences a rapid pressure increase of almost 7 psi.

However, TAC-treated process 202, which operated for 7 cycles of 40 minutes each, only experienced a gradual pressure increase of almost 6 psi. The conductivity of each cycle ranged between 8500-9300 μS/cm with an alkalinity of 2600-3500 mg/L CaCO₃. This shows that the TAC media is effective in mitigating the scaling issues in EDR systems as indicated by the pressure increase in the system.

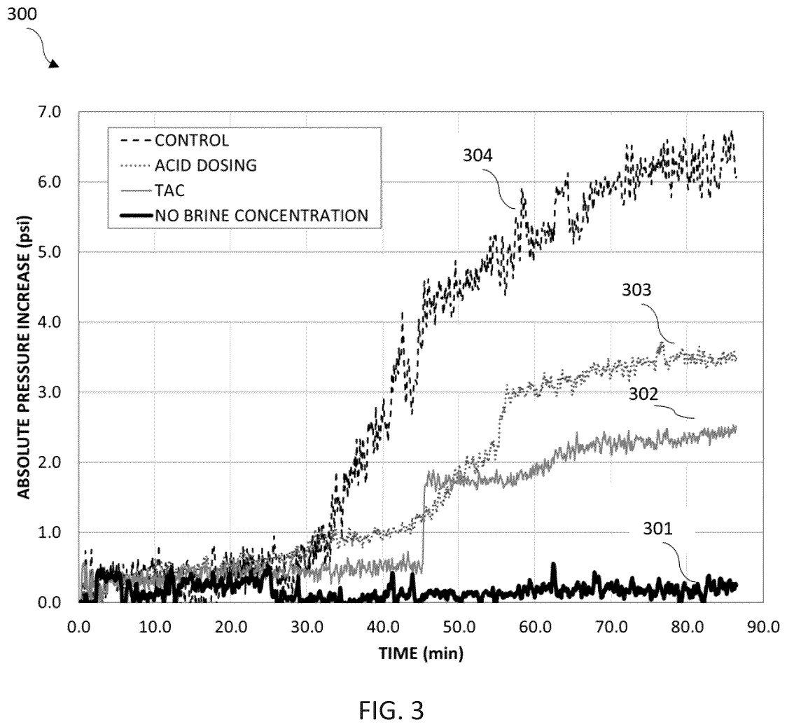

Example 2: FIG. 3 shows a comparison of the pressure increase in the system of FIG. 1 between systems with and without brine concentration, and brine concentration with TAC treatment and acid dosing, according to some embodiments. As explained above, system pressure can be a direct indicator of the amount of scaling in the system. Accordingly, FIG. 3 shows the pressure increases of three different processes: a baseline (no brine concentration) 301, a TAC-treated process 302, an acid dosed-process 303, and a control (no TAC nor acid-dosing) 304. The baseline 301 represents a system without a brine recirculation loop, wherein both the process and brine streams flow through and out of the system, i.e. process and brine inlet streams flow into the electrodialysis device once and the outlet streams flow to drain. The TAC-treated process 302 represents a system having a TAC-treated brine stream. The acid-dosed process 303 represents a process having a brine stream treated with acid dosing. Finally, the control 304 represents a system with an untreated brine recirculation loop.

As expected, without brine concentration and scaling events (i.e., baseline 301), no pressure increase in the system is observed. When brine recirculation (concentration) is introduced in the system (i.e., control 304), the system pressure increases 7 psi within 90 minutes of run time, which indicates scaling events occurring in the system. In the process that uses acid dosing (i.e., acid dosed-process 303), acid is dosed constantly throughout the 90 minute run into the recirculating brine stream such that a total of 4 mL of 31% HCl is used throughout the experiment. As shown in the FIGURE, the acid dosing reduces the pressure increase in the system by about half when compared to the control case 304. When a TAC filter is used to treat the brine stream (i.e., TAC-treated process 302), the system pressure increase is reduced even further compared to acid dosing, and by more than half compared to the control case. This indicates that the TAC filter is effective in sequestering the hardness ions and rendering them unable to scale the system.

Table 1, below, shows the conductivity, alkalinity, and the concentration of various dissolved ions in each of the process streams depicted in FIG. 3.

| | | BRINE | | | | | |
|---|---|---|---|---|---|---|---|
| | | CONDUCTIVITY | ALKALINITY | Na⁺ | K⁺ | Mg²⁺ | Ca²⁺ |
| | STREAM | (uS/cm) | (mg/L) | (ppm) | (ppm) | (ppm) | (ppm) |
| 301 | NO | 502 | 150 | 32 | 0.69 | 4.25 | 61.7 |
| | CONCENTRATION | | | | | | |
| 302 | TAC | 15100 | 4332 | 1910 | 96.2 | 372.2 | 2066.1 |
| 303 | ACID | 15080 | 3960 | 1252 | 61.3 | 223 | 2750 |
| 304 | CONTROL | 15270 | 4390 | 2045 | 443 | 492 | 2523 |

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A water treatment system for reducing water hardness, comprising:
an electrodialysis device comprising a brine inlet stream, a feed stream, a brine outlet stream, and a product outlet stream,
a template assisted crystallization (TAC) filter comprising a brine inlet stream and a brine outlet stream, wherein the brine inlet stream comprises the brine outlet stream of the electrodialysis device and the brine inlet stream of the electrodialysis device comprises the brine outlet stream of the TAC filter,
wherein a system pressure of the water treatment system is 30-60% less than a system pressure of a process without a TAC filter.

2. The water treatment system of claim 1, comprising an acid supply and an acid feed stream, wherein the brine inlet stream of the electrodialysis device comprises the brine outlet stream of the TAC filter and the acid feed stream.

3. The water treatment system of claim 1, wherein the feed stream comprises water having 30-35 ppm Na⁺.

4. The water treatment system of claim 1, wherein the feed stream comprises water having 0-5 ppm Mg²⁺.

5. The water treatment system of claim 1, wherein the feed stream comprises water having 0-3 ppm K⁺.

6. The water treatment system of claim 1, wherein the feed stream comprises water having 40-70 ppm Ca²⁺.

7. The water treatment system of claim 1, wherein a dissolved ion concentration of the product outlet stream is at least 25% less than the dissolved ion concentration of the feed stream.

8. The water treatment system of claim 1, wherein a dissolved ion concentration of the product outlet stream is at least 40% less than the dissolved ion concentration of the feed stream.

9. The water treatment system of claim 2, wherein the acid feed stream comprises at least one of 31% hydrochloric acid or 98% sulfuric acid.

10. A method for reducing water hardness, the method comprising:
routing a brine inlet stream and a feed stream to an electrodialysis device; and
routing a brine outlet stream of the electrodialysis device to a template assisted crystallization (TAC) filter,
wherein the brine inlet stream of the electrodialysis device comprises a brine outlet stream of the TAC filter, and a system pressure of the method is 30-60% less than a system pressure of a method without a TAC filter.

11. The method of claim 10, comprising an acid supply and an acid feed stream, wherein the brine inlet stream of the electrodialysis device comprises the brine outlet stream of the TAC filter and the acid feed stream.

12. The method of claim 10, wherein the feed stream comprises water having 30-35 ppm Na⁺.

13. The method of any of claim 10, wherein the feed stream comprises water having 0-5 ppm mg²⁺.

14. The method of any of claim 10, wherein the feed stream comprises water having 0-3 ppm K⁺.

15. The method of any of claim 10, wherein the feed stream comprises water having 40-70 ppm Ca²⁺.

16. The method of any of claim 10, wherein a dissolved ion concentration of a product outlet stream flowing from the electrodialysis device is at least 25% less than the dissolved ion concentration of the feed stream.

17. The method of any of claim 10, wherein a dissolved ion concentration of a product outlet stream flowing from the electrodialysis device is at least 40% less than the dissolved ion concentration of the feed stream.

18. The method of any of claim 10, wherein the acid feed stream comprises at least one of 31% hydrochloric acid or 98% sulfuric acid.
